(19) United States
(12) Patent Application Publication
(10) Pub. No.: US 2003/0217293 A1
(43) Pub. Date: Nov. 20, 2003

(54) System for permitting access to an electronic device when the password is not known

(76) Inventor: Tony J. Lee, Pullman, WA (US)

Correspondence Address: JENSEN + PUNTIGAM, P.S., SUITE 1020, 2033 6TH AVE, SEATTLE, WA, 98121, US

(21) Appl. No.: 10/150,453

(22) Filed: May 17, 2002

(51) Int. Cl. G06F 12/14

(52) U.S. Cl. 713/202

(57) ABSTRACT

An electronic device will include physical access protection over which a user has control, such as by a key, and password protection which may have been forgotten or otherwise is not in the immediate possession of the user. The apparatus is configured so that removal of power to the apparatus followed by reapplication of power, such as by a switch or a fuse, is recognized by the apparatus, which is configured to permit the user a predetermined period of time to gain access to the apparatus. After access is gained, the user then has an unlimited time to change the password to an alternate password recognizable by the apparatus or to determine the original password or eliminate the password protection. The user then has the ability to alter the functional configuration of the apparatus, such as through changing user-defined settings, providing upgraded firmware for the apparatus or other functions.

### TECHNICAL FIELD

This invention relates generally to security systems using a password to prevent access to selected equipment, and more particularly concerns a system for a user to gain access to password-secured equipment when the password is either not known or has been forgotten by the user.

### BACKGROUND OF THE INVENTION

Access to an intelligent electronic device is often protected with a security system. Examples of secured equipment include computers used for particular applications and, in the present case, a microprocessor-based relay which performs protection functions for a power line. The security system will usually include both physical access protection and password protection. A protective relay, for instance, is often enclosed within a housing or a building. The housing will typically have doors which are secured by a lock and key. Physical access protection will usually prevent vandalism as well as unauthorized modification/use of the device. Physical access normally is a first level type of protection.

A protective relay will typically have a serial port, usually in the front panel, with a control interface, to provide access to the electronic processing portions in the relay. This access permits the user to change various settings of the relay, i.e. to change its protection operations, open and close the circuit breaker controlled by the relay, and change the relay's firmware, among several possible changes.

While a protective relay or other equipment is physically protected by the housing, it will frequently have an additional, second level of protection in the form of a password to control access to its processing functions. With password protection, a user connecting to a serial port on the device will have to enter a particular password, previously established in the relay, in order to gain access through the control interface to make changes or enter information to the device. This secondary level of protection is electronically implemented and controlled. Password protection is particularly important when the serial communications port can be connected to a remote access device, such as through a network, radio, modem or other means.

It is, however, relatively common for a legitimate user to forget or to misplace the password. This is inconvenient and causes loss of valuable time to obtain the password as well as frustration on the part of the user. In a typical current arrangement, password protection can be defeated with a particular sequence of steps taken by the user. In one method, actual physical access by the user, such as with a key, is regarded as evidence of a user's right to access the equipment. Such a user is permitted to defeat the password protection by a sequence of steps which include removing the device from service, disassembling the device (or removing the cover of the equipment), installing (or removing) a temporary jumper or other element at a selected portion of the equipment, reassembling the device and then reapplying power.

Upon reapplication of power, the equipment senses the temporary modification of the jumper element or other element and disables the password protection. The user can then establish communication with the equipment, or a remote user can be notified that the password protection has been disabled so that the remote user can have access to the equipment.

The existing password of the equipment may then be changed by the user, since access is typically provided to this level. The user must then again disassemble the device, restore the password protection (with the new password) by removing the jumper and reassemble the equipment. The equipment is then again placed into service, and the user then can use the new password (known to the user) to carry out any desired modification to the equipment.

However, this arrangement does have disadvantages, since errors may be produced in the equipment due to incorrect or faulty disassembly and assembly, and since the equipment is not available for service when it is being disassembled and then reassembled.

It is thus desirable that a reliable and faster method of defeating password protection be implemented to avoid the delay in access which would otherwise be encountered when a password has been forgotten or misplaced.

### SUMMARY OF THE INVENTION

Accordingly, the present invention is a system for preventing access by a user to a password-protected apparatus when the password is not known by the user, comprising: a system for protecting physical access to the apparatus, wherein the user has control over the physical access system, such as with a key; and an element conveniently accessible to the user for removing and then reapplying power to the apparatus, wherein the apparatus is configured to permit access thereafter to at least some portions of the apparatus.

### BRIEF DESCRIPTION OF THE DRAWING

FIG. 1 is a drawing showing a front panel of a typical electronic relay.

FIG. 2 is a block diagram showing the functional elements of such a relay.

FIG. 3 is a block diagram illustrating the password access portion of the present invention.

### BEST MODE FOR CARRYING OUT THE INVENTION

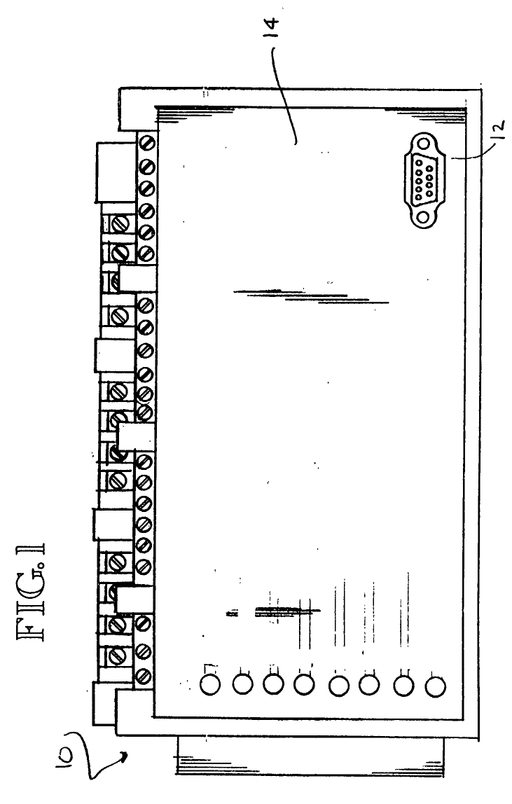

FIG. 1 shows a front panel of an intelligent electronic device, referred to generally at 10, which in this example is a microprocessor-based relay for protection of electric power lines. The relay processes input voltages and currents to determine faults on a power line, and produces an output signal to trip a circuit breaker when a fault on the power line has been determined. In order to carry out its protection function, the relay 10 includes firmware which controls many of the processing functions; further, the relay has a number of user-changeable settings which establish the parameters of the processing, including preestablished values against which the actual voltage and current conditions on the line are compared, as well as other aspects of the protection functions. If the power line conditions exceed the setting values, a fault indication is provided by the relay. The user has access to the device to change the settings or alter/replace the firmware through a serial port, such as shown at 12, in the front panel 14.

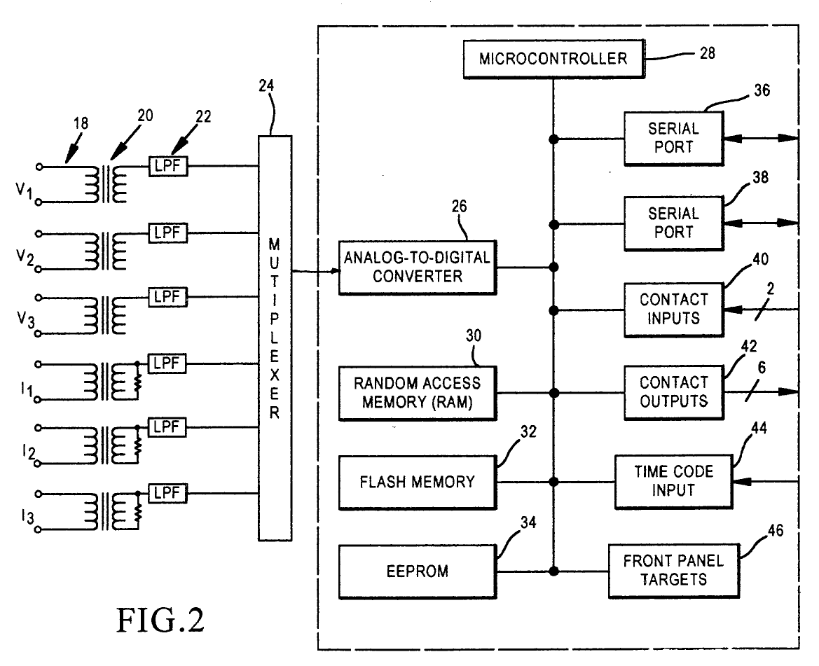

FIG. 2 shows a functional diagram of such a microprocessor-based relay, including the basic processing structure and the input connections to the relay. It should be understood, however, that the relay shown is only one example of an intelligent electronic device which can use the password access system of the present invention. Examples of other similar equipment using passwords include: control and data acquisition equipment and communications equipment.

The three phase input voltages, V₁, V₂ and V₃, and the three phase input currents, I₁, I₂ and I₃, are shown as a group at 18. The voltages and currents are applied through step-down transformers 20 and then through low-pass filters 22 and a multiplexer 24. The output of the multiplexer 24 is applied to an analog-to-digital converter 26, the output of which is applied to microcontroller 28. Also connected to the microcontroller 28 are RAM memory 30, flash memory 32 and read-only memory (EEPROM) 34. Serial ports are provided at 36 and 38, contact inputs and contact outputs at 40 and 42 which provide, respectively, access to the relay from other devices connectable thereto and for control by the relay of other devices, such as a circuit breaker. Time code input and front panel lights/targets are illustrated at 44 and 46. The serial port 36, which is an EIA232C port in the embodiment shown, provides serial port access to microcontroller 28 and to the various memory elements of the device.

As indicated above, the relay 10 in the field is typically located in a housing or a building, the housing for instance being physically locked and accessible with a key. Legitimate users will have a key for physical access to the relay. The present system of permitting access to secured equipment is not directed toward physical access. Typical requirements of physical access, such as a key, are not affected. Physical access to the power connection to the relay can also be protected, such as again with a lock and key. Hence in some cases, a relay or other instrument will have two types of physical protection, one for the relay itself, the other for the power connection to the relay. This may occur particularly for those instruments having password overcoming procedures described above.

In devices such as shown in FIGS. 1 and 2, password protection must be satisfied to permit a user access to the internal operation and structure of the relay, in order to change the operational settings of the device, provide control signals for the output contacts which connect to other devices, such as a circuit breaker, and to modify the existing firmware. Other functions/operations can be altered as well.

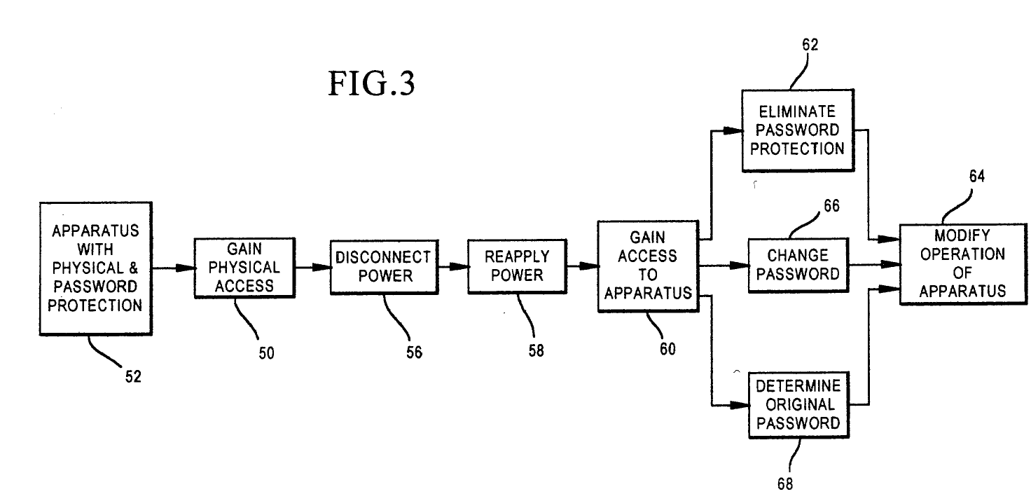

The present invention is directed toward permitting control access to the device when the user forgets or misplaces the password, in which case the user would ordinarily be denied access to the device. Ordinarily, the user would contact another party to obtain the password or follow a particular access procedure, like that explained above, which is time-consuming and cumbersome. The present invention permits convenient access to a password-protected device with at least the same security as present access strategies. The present system is shown in flow diagram form in FIG. 3.

With the present invention, a user without the password, upon gaining physical access (block 50) to the protected device (block 52) such as with a key, and then connecting to the serial port on the equipment with an access device, will first remove the power from the device (block 56) and then reapply the power (block 58). Removal and reconnecting the supply power can be readily accomplished by either operating an external switch provided for this function on the device, or by removing and reinstalling fuses external to the device. A particular arrangement may require physical access to the power connection system.

The apparatus is programmed so that upon removal of power and then reapplication of power, the apparatus disables or reduces the level of password protection required to gain access (block 60) to the device for a predetermined period of time, such as for example one minute. In a particular embodiment, reapplication of power may be required within a certain period of time for the present system to operate, but this is not necessary. After access has been granted during the predetermined period of time, the local or remote user thereafter has an unlimited amount of time to change the password (block 66) or obtain the original password (block 68). Alternatively, such time could be limited.

In another embodiment, password protection could be completely disabled (block 62) by the user so that, if the user has gained access during the predetermined period of time, after power has been removed and reconnected, the user can accomplish any desired modifications of the device, including modification of settings, establishment of new settings, upgrading the firmware, etc. (block 64).

Access to the device could be restricted to selected portions of the apparatus under the present system. In such an arrangement, the user will not be able to make changes to the apparatus to the extent that a user having the password could. The level of access will depend on the device configuration.

During the predetermined period of time, which can be varied, a user who is physically present at the device, or a remote user, can gain access to the device and thereafter change the password or determine the existing password, as described above. During the process, the device continues to be in service. In fact, the only time that the apparatus is removed from service is the small amount of time between the removal of power and the reapplication of power. This arrangement maximizes the device's availability and reduces the time that the device is essentially out of service.

An alternate password may be used (block 66), if the apparatus is configured to accept the alternate password. The alternate password may be displayed on the device or supplied to the user from a secure location, with directions for retrieving the password displayed physically on the device. Typically, the device will use the alternate password thereafter.

In any embodiment, the device can be configured to permit access to only selected areas (functions) of the apparatus. Alternatively, full access can be provided, depending on the design configuration and the desires of the designer.

Hence, a system and method has been disclosed for permitting access to an electronic or similar device which is otherwise protected by a password, in particular situations where a user does not have the possession of the password.

Although a preferred embodiment of the invention has been described for purposes of illustration, it should be understood that various changes, modification and substitutions may be incorporated in the invention without departing from the spirit of the invention which is defined in the claims which follow.

What is claimed:

1. A system for permitting access by a user to a password-protected apparatus when the password is not known by the user, comprising:
a system for protecting physical access to the apparatus; and
an element, accessible to a user who has gained physical access to the apparatus, operable by the user to remove power from and then reapply power to the apparatus, wherein the apparatus is configured to permit access thereafter to at least some selected portions of the apparatus.

2. A system of claim 1, wherein operation of the element to remove and reapply power to the apparatus results in the user having a predetermined amount of time to gain access to the apparatus and wherein following gaining of said access, the user has an unlimited amount of time to change the password or determine the original password.

3. A system of claim 2, wherein the apparatus is configured to accept an alternative password and the alternative password is provided on the apparatus or from a source provided on the apparatus.

4. A system of claim 1, wherein the reapplication of power must be accomplished within a predetermined period of time.

5. A system of claim 1, wherein said permitted access is to the entire apparatus and all of its functions.

6. A system of claim 1, wherein the user can eliminate the password protection of the apparatus.

7. A system of claim 2, wherein the limited time to obtain access is approximately one minute.

8. A system of claim 1, wherein the apparatus is only out of service for the time that power is removed from the apparatus to the time that power is reapplied to the apparatus.
